(19) United States
(12) Patent Application Publication
(10) Pub. No.: US 2024/0196154 A1
(43) Pub. Date: Jun. 13, 2024

(54) OPTIMISED REAL-TIME AUDIO PLAYBACK

(71) Applicant: SAGEMCOM BROADBAND SAS, Bois-Colombes (FR)

(72) Inventors: Pierre SABATIER, Bois-Colombes (FR); Gilles BOURGOIN, Bois-Colombes (FR)

(21) Appl. No.: 18/538,437

(22) Filed: Dec. 13, 2023

(30) Foreign Application Priority Data
Dec. 13, 2022 (FR) 2213266

(51) Int. Cl. H04S 7/00

(52) U.S. Cl. CPC H04S 7/303

(57) ABSTRACT

A method incudes the preliminary steps of producing a map of a room, wherein one or more sound sources are located; acquiring acoustic features of the walls; performing a simulation, by using the map and the acoustic features, of a propagation in the room of sounds emitted by the sound sources; producing the reference audio parameters; the method further comprising the operational steps of: determining a current position of a user in the room; playing an audio signal back by the sound sources by applying the current audio parameters obtained from the reference audio parameters, and which depend on the current position.

The invention relates to the field of audio playback systems.

### BACKGROUND OF THE INVENTION

Numerous pieces of equipment are today provided with loudspeakers, and propose excellent quality audio playback.

These pieces of equipment naturally include speakers (in particular, smart speakers), soundbars, televisions, voice assistants, smartphones, etc. Also, now, these include improved set-top boxes (or STB), provided with loudspeakers.

When a user has several pieces of recent audio playback equipment, they can generally configure them to form a multichannel system.

To further improve the user experience, it is sought to optimise the quality of the audio playback, according to the position of the user in the room, wherein the audio playback equipment is located.

Thus, a system is known, which implements a calibration phase, consisting of positioning a microphone in a reference position, then of controlling the audio playback equipment, such that it produces a test sound signal, which is captured by the microphone. The result of the capture is used to adjust the audio parameters (delay and equalisation) of each piece of audio playback equipment.

This system has the following disadvantage. The audio parameters make it possible to optimise the audio playback in the reference position only, and the calibration phase must therefore be repeated, each time that the user moves.

Also, a system is known, which comprises a plurality of speakers, each provided with a microphone. This system performs the following calibration phase. The user positions themselves in a reference position. They then pronounce a keyword, which is captured by the microphone of each speaker, which makes it possible to determine the distances between the different speakers and the user. The audio parameters make it possible to optimise the audio playback in the reference position. However, again, in this system, the calibration phase must be repeated, each time that the user moves.

### AIM OF THE INVENTION

The invention aims, in a room wherein one or more sound sources are positioned, to optimise the audio playback according to the current position of a user, without repeating any calibration phase.

### SUMMARY OF THE INVENTION

In view of achieving this aim, an audio playback method is proposed, implemented by one or more pieces of master equipment, and comprising a preliminary phase, comprising the steps of:
producing a map of a room, wherein one or more sound sources are located, which comprises a position of each sound source and a position of walls of the room;
acquiring the acoustic features of the walls;
performing a simulation, by using the map and the acoustic features of the walls, to simulate a propagation in the room of sounds emitted by the sound sources;
from results of the simulation, producing, for each reference position of a plurality of reference positions defined in the room, and for each sound source, reference audio parameters making it possible to optimise an audio playback of said sound source in said reference position;

the audio playback method further comprising an operational phase, comprising the steps, carried out in real time, of:
determining a current position of a user in the room;
playing an audio signal back by the sound sources, by applying current audio parameters obtained from the reference audio parameters, and which depend on the current position.

The simulation, performed during the preliminary phase, therefore makes it possible to obtain reference audio parameters associated with reference positions, which can be distributed in the entire room.

During the operational phase, the master equipment determines the current position of the user, and applies current audio parameters by the sound sources, which depend on the current position and which are obtained from reference audio parameters.

The audio playback is therefore optimised in real time, whatever the position of the user in the room, without it being necessary to repeat the preliminary phase (except for if the position of the sound sources and/or the materials of the walls are significantly modified).

In addition, an audio playback method such as described above is proposed, wherein the simulation uses a ray tracing technique.

In addition, an audio playback method such as described above is proposed, wherein the acoustic features of the walls comprise, for each wall, values for different frequencies of an absorption coefficient of a material of the wall or of a category of materials including said material.

In addition, an audio playback method such as described above is proposed, wherein the reference audio parameters comprise, for each reference position and for each sound source, gain and phase shift values for different frequencies, associated with said sound source.

In addition, an audio playback method such as described above is proposed, wherein the reference positions of the plurality of reference positions are nodes of a grid having a predefined grid cell length.

In addition, an audio playback method such as described above is proposed, wherein, during the operational phase, the current audio parameters which are applied are the reference audio parameters of a node closest to the current position.

In addition, an audio playback method such as described above is proposed, wherein, during the operational phase, the current audio parameters which are applied are obtained by averaging reference audio parameters of several nodes closest to the current position.

In addition, an audio playback method such as described above is proposed, wherein, at least one of the pieces of master equipment comprises a first UWB module, and wherein the production of the map and/or the detection of the current position of the user are implemented by using the first UWB module.

In addition, an audio playback method such as described above is proposed, wherein the preliminary phase comprises the steps, to determine the position of the walls, of:
emitting a first message intended for the user to request them to perform a route along the walls closest to these;
determining the position in real time of the user when they perform said route, and determining the position of the walls from this position in real time.

In addition, an audio playback method such as described above is proposed, wherein the user is provided, when they perform said route, with a piece of mobile equipment comprising a second UWB module, the determination of the position in real time of the user being made by a UWB geolocation technique, by using the first UWB module and the second UWB module.

In addition, an audio playback method such as described above is proposed, wherein, during the operational phase, the user is provided with a piece of mobile equipment comprising a second UWB module, the determination of the current position of the user being made by a UWB geolocation technique made by using the first UWB module and the second UWB module.

In addition, an audio playback method such as described above is proposed, wherein the first UWB module is arranged to implement a UWB radar technology, the determination of the position of the walls of the room being made by the master equipment, by using said UWB radar technology.

In addition, an audio playback method such as described above is proposed, wherein the user, during the preliminary phase, is provided with a piece of mobile equipment comprising a second UWB module, the preliminary phase comprising the step, for at least one sound source, of emitting a second message intended for the user to request them to position the mobile equipment in the immediate proximity of the sound source, the position of said sound source thus being assimilated to the position of the mobile equipment, which is determined by a UWB geolocation technique by using the first UWB module and the second UWB module.

In addition, an audio playback method such as described above is proposed, wherein at least one sound source comprises a UWB tag, the master equipment being arranged to determine the position of said sound source, by using a UWB geolocation technique made by using the first UWB module and the UWB tag.

In addition, a piece of master equipment comprising a first UWB module is proposed, arranged to perform a geolocation, and a processing unit arranged to implement the audio playback method such as described above.

In addition, a piece of master equipment such as described above is proposed, the master equipment being a set-top box.

In addition, a computer program is proposed, comprising instructions which make the processing unit of the master equipment, such as described above, execute the steps of the audio playback method such as described above.

In addition, a recording medium which can be read by a computer is proposed, on which the computer program such as described above is recorded.

The invention will be best understood, in the light of the description below of particular, non-limiting embodiments of the invention.

### BRIEF DESCRIPTION OF THE DRAWINGS

Reference will be made to the accompanying drawings, among which:

FIG. 1 represents a room seen from above, wherein a set-top box, a television and two speakers are positioned;

FIG. 2 represents a set-top box, wherein the invention is implemented;

FIG. 3 illustrates the ray tracing technique, and represents the sound rays between a source and a reference position (one single ray in this case), without reflection on the walls;

FIG. 4 is a figure similar to FIG. 3, with a reflection on the walls;

FIG. 5 is a figure similar to FIG. 3, with two reflections on the walls;

FIG. 6 is a figure similar to FIG. 3, with three reflections on the walls;

FIG. 7 represents a map made during the mapping step, on which, in addition, a virtual listener is represented;

FIG. 8 represents results of the ray tracing simulation;

FIG. 9 is a figure similar to FIG. 8, obtained by considering the directivity of the speaker of the sound source;

FIG. 10 illustrates the transmission of the current audio parameters of the set-top box to the sound sources, and the playback of an audio signal.

### DETAILED DESCRIPTION OF THE INVENTION

In reference to FIG. 1, a set-top box 1, a television 2 and two speakers 3a, 3b are located in a room.

The set-top box 1 is connected to the television 2, for example by an HDMI (High-Definition Multimedia Interface)-type cable.

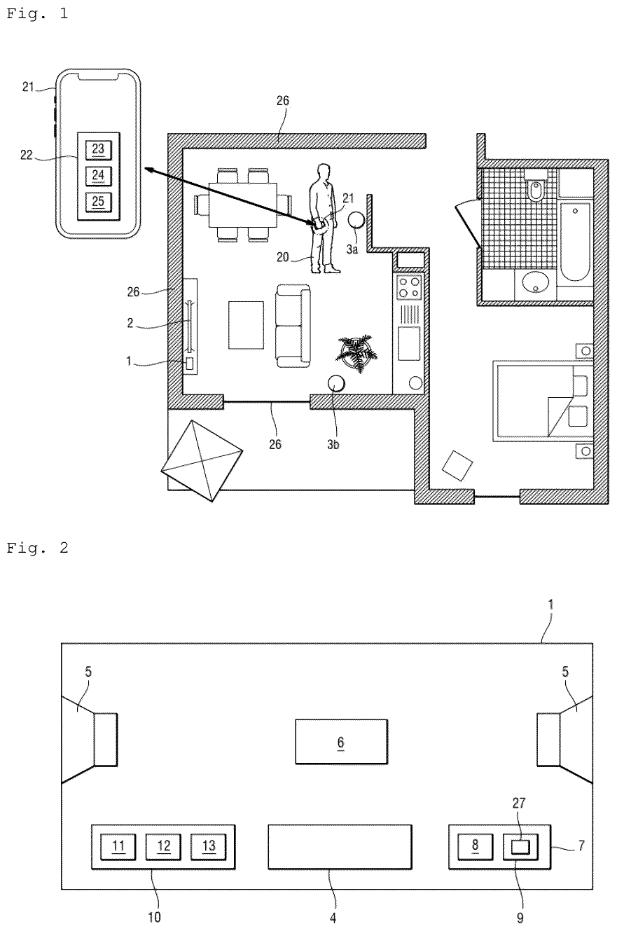

In reference to FIG. 2, the set-top box 1 comprises components 4 conventionally present in a set-top box 1, and in particular, components arranged to acquire an audio-video stream coming from any source (satellite television network, internet connection, BlueRay player, etc.) and comprising an audio signal and a video signal, and to process and transmit to the equipment to which it is connected (in this case, the television 2 and the speakers 3a, 3b) the audio signal and the video signal for them to be played back.

The set-top box 1 in addition comprises two loudspeakers 5, as well as an audio module 6 arranged to acquire, process, amplify audio signals, and transmit them to the loudspeakers 5.

The set-top box 1 also comprises a processing unit 7. The processing unit 7 comprises at least one processing component 8 (electronic and/or software), which is, for example, a “general” processor, a processor specialising in processing the signal (or DSP, Digital Signal Processor), a microcontroller, or a programmable logic circuit, such as an FPGA (Field Programmable Gate Array) or an ASIC (Application Specific Integrated Circuit). The processing unit 7 also comprises one or more memories 9 (and, in particular, one or more non-volatile memories), connected to or integrated in the processing component 8. At least one of these memories 9 forms a recording medium which can be read by a computer, on which at least one computer program is recorded, comprising instructions which make the processing component 8 execute at least some of the steps of the audio playback method which will be described below.

The set-top box 1 in addition comprises a first UWB (Ultra Wide Band) module 10, which comprises a UWB communication component 11, an assembly of at least one UWB antenna 12 and a microcontroller 13. The microcontroller 13 is connected to the processing unit 7 (via a series connection, for example). The microcontroller 13 interacts with the UWB communication component 11 and with the processing unit 7.

The assembly of at least one UWB antenna 12 comprises, in this case, two UWB antennas which are connected to the UWB communication component 11.

The first UWB module 10 can thus measure not only the distance between a piece of external equipment which itself emits and receives UWB signals, but also the angle of arrival of the UWB signals emitted by said external equipment.

The microcontroller 13 provides, in particular, to the processing unit 7, location information produced by the first UWB module 10.

The audio playback method is implemented by one or more pieces of master equipment. In this case, and in a non-limiting manner, the audio playback method is fully implemented by the processing unit 7 of the set-top box 1 (which is therefore the master equipment).

The room, wherein the system which has just been described is located, belongs to the dwelling of a user 20.

The user 20 is provided with a piece of mobile equipment 21, a smartphone in this case, which integrates a second UWB module 22. The second UWB module 22 comprises a UWB communication component 23, an assembly of at least one UWB antenna 24 and a microcontroller 25.

The audio playback method aims to optimise the audio playback performed by the set-top box 1 and the speakers 3a, 3b according to the position of the user 20 in the room.

The audio playback method comprises a preliminary phase and an operational phase.

The preliminary phase can be assimilated to a calibration phase.

The operational phase, itself, corresponds to the normal, usual use of their equipment by the user 20. When the user 20 moves in the room and when they listen to an audio content, the audio playback method optimises the acoustic experience of the user 20 in real time, according to their position (and whatever this is).

The preliminary phase first comprises a mapping step, which consists of producing a map of the room. This map comprises at least the position of each sound source, i.e. in this case, the set-top box 1 and the two speakers 3a, 3b, and a position of the walls 26 of the room.

In this case, by “walls”, this means all the elements of the room which extend vertically and which delimit the surface of the room: walls, windows, bay windows, furniture (such as cabinets), etc.

A first embodiment of this mapping step is described.

To determine the position of the walls 26, the processing unit 7 of the set-top box 1 first emits a first message intended for the user 20 to request them to perform a route along the walls 26 closest to these.

The processing unit 7 determines the position in real time of the user 20 when they perform said route (this is, more specifically, the position of the smartphone 21), and thus determines the position of the walls 26 in the room from this position in real time. The processing unit 7 therefore assimilates the plot of the route performed by the user 20 on the basis of the walls 26.

The determination of the position in real time of the user 20 is made by a UWB geolocation technique, by using the first UWB module 10 (of the set-top box 1) and the second UWB module 22 (of the smartphone 21). As has been seen above, the first UWB module 10 precisely locates the smartphone 21 from UWB signals emitted by this.

To determine the position of each sound source, the processing unit 7 emits a second message intended for the user 20 to request them to position the smartphone 21 in the immediate proximity of the sound source. For example, the user places the smartphone 21 on or against the sound source, or is itself positioned just to the side of the sound source. The position of said sound source is thus assimilated to the position of the smartphone 21, which is determined by a UWB geolocation technique, by using the first UWB module 10 and the second UWB module 22.

Naturally, in this case, this only relates to the speakers 3a, 3b, as the position of the set-top box 1 (as a sound source) is known.

The processing unit 7 then acquires the acoustic features of the walls 26.

The acoustic features of the walls 26 comprise, for each wall 26, values for different frequencies of an absorption coefficient of a material of the wall 26. By “a material of the wall”, this means either a material with which the wall is manufactured, or a material of a coating covering the internal wall (side of the room) of the wall, or a material of any element positioned on or against the wall (a wall covering, for example).

The user uses, for example, an application loaded into their smartphone 21 to inform about the type of material of the walls 26 of the room (concrete, window, curtain, parquet, carpet, etc.). This information is transmitted to the processing unit 7 via any communication channel between the smartphone 21 and the set-top box 1 (for example, by Wi-Fi, Bluetooth, etc.).

The processing unit 7 uses a table 27 stored in one of the (non-volatile) memories 9. The table 27 associates an absorption coefficient for each frequency with each material.

Alternatively, it is possible to provide several general categories, which each groups together a plurality of materials. Then, for a given wall 26, either the user 20 informs about the material and the processing unit 7 deduces a general category to which said material belongs, or the user 20 directly informs about the general category to which said material belongs.

An example of a table 27 is given below. This table 27 associates, for each general category of materials and for several frequencies, an absorption coefficient associated with said general category and with said frequency.

| | Acoustic absorption coefficient | | | | | |
|---|---|---|---|---|---|---|
| | of the material | | | | | |
| | 125 | 250 | 500 | 1 | 2 | 4 |
| General category of materials | Hz | Hz | Hz | kHz | kHz | kHz |
| Windows - untreated floor/ | 0.10 | 0.10 | 0.10 | 0.10 | 0.10 | 0.10 |
| wall | | | | | | |
| Wall coverings - curtains - | 0.10 | 0.20 | 0.40 | 0.50 | 0.65 | 0.60 |
| carpet | | | | | | |
| Absorbing treatment | 0.20 | 0.55 | 0.60 | 0.70 | 0.80 | 0.90 |

In this case, therefore, there are three general categories of materials: windows—untreated floor/wall; wall coverings—curtains—carpet; absorbing treatment.

The processing unit 7 thus performs a simulation, by using the map and the acoustic features of the walls 26, to simulate a propagation in the room of sounds emitted by the sound sources.

The simulation uses a ray tracing technique. This technique makes it possible to define the acoustic impact of the room on the acoustic propagation of the sound waves generated by the sound sources: set-top box 1 and speakers 3a, 3b.

First, the principle of the ray tracing technique is described. This technique consists of drawing the rays from a sound source to the measuring point by considering the paths with the reflections on the walls, and by forming the sum of the contributions of each ray.

This simulation therefore reproduces, for each reference position from a plurality of reference positions, the route of the sound rays between each sound source and said reference position, by considering reflections on the walls and the ceiling.

The simulation considers each reflection on the walls 26 by evaluating the level Nr of the reflected sound wave, according to the level Ni of the incident sound wave and of the absorption coefficient of the wall 26 against which the wave is reflected, as follows:

Nr=Ni×α
where α is the absorption coefficient of the material of the wall (between 0 and 1).

For example, in the case of carpet, at 1 kHz, α=0.5 is achieved. The level of the reflected sound wave is thus equal to the level of the incident sound wave divided by 2 (that is a reduction of 6 dB).

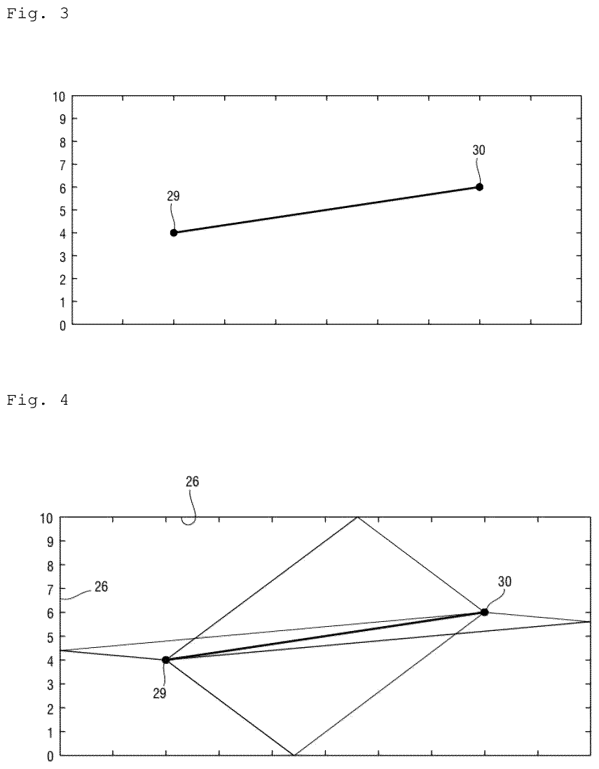

In FIG. 3, a direct sound ray (without reflection on the walls 26) is seen between a sound source 29 and a reference position 30.

In FIG. 4, the sound rays are seen with a reflection on the walls 26.

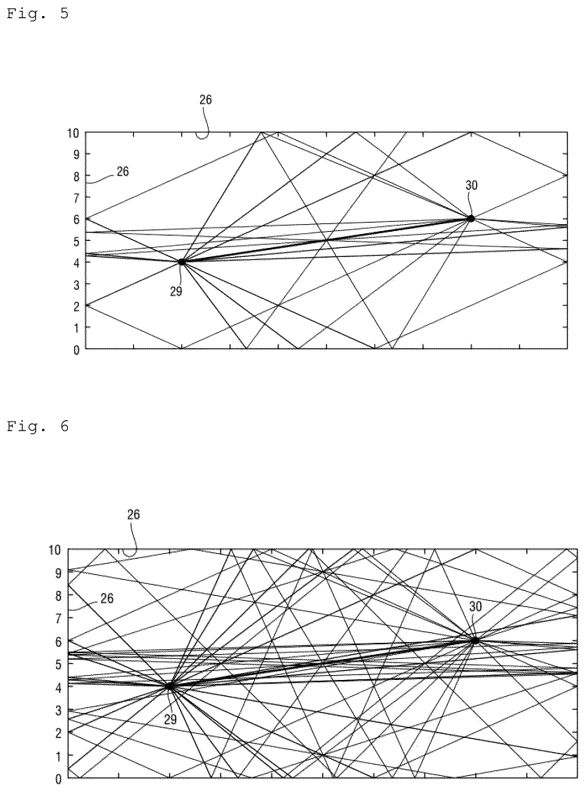

In FIG. 5, the sound rays are seen with two reflections on the walls 26.

In FIG. 6, the sound rays are seen with three reflections on the walls 26.

These simulations are performed for each sound source of the room, for each reference position, and for a plurality of frequencies.

The calculation of the ray tracing equals the positioning of an ambient microphone via its physical measurement. All the necessary data are calculated, like for a calibration of the microphone. All the data for reducing the listening point with respect to the different speakers are thus calculated. The data for the processing of immersive sound are calculated to compensate for the distances and the reflections.

From the results of the simulation, the processing unit 7 produces, for each reference position of the plurality of reference positions, and for each sound source, reference audio parameters making it possible to optimise an audio playback of said sound source in said reference position.

The reference audio parameters comprise, for each reference position and for each sound source, gain and phase shift values for different frequencies, associated with said sound source.

The reference positions of the plurality of reference positions are, in this case, nodes of a grid having a predefined grid cell length.

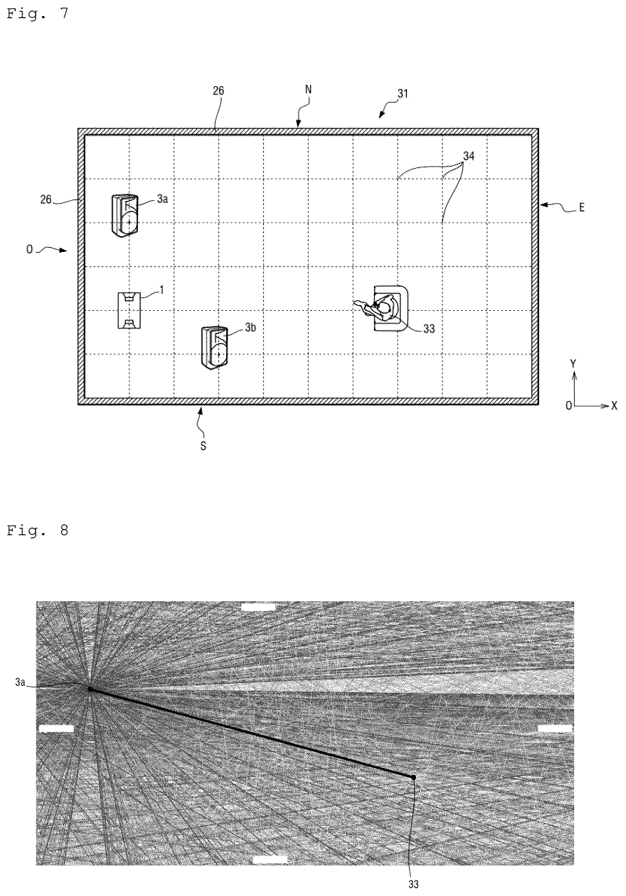

In reference to FIG. 7, a map 31 has been produced by the set-top box 1. The set-top box 1 and the speakers 3a, 3b (omnidirectional speakers) are located in a parallelepiped living room of 6 m×10 m.

Therefore, the position of the sound sources 1, 3a, 3b and of the walls 26 is seen on this map 31.

The grid 32 is defined on this map 31. The grid cell is, for example, equal to 1 m.

Also, a virtual listener 33 is seen in FIG. 7, which, naturally, does not appear, in reality, on the map 31. The virtual listener is positioned on one of the nodes 34 of the grid 32.

The simulation of the sounds emitted by the speaker 3a is focused on.

The speaker 3a is positioned on one of the nodes of the grid.

The reference positions correspond to the nodes of the grid.

The delay r of the sound signal emitted by the speaker 3a is directly linked to the distance between the speaker 3a and the virtual listener 33:

r=[(Xₗᵢₛₜₑₙₑᵣ−Xₛₚₑₐₖₑᵣ)²+(Yₗᵢₛₜₑₙₑᵣ−Yₛₚₑₐₖₑᵣ)²]^{1/2}/c,

where (Xₗᵢₛₜₑₙₑᵣ; Yₗᵢₛₜₑₙₑᵣ) and (Xₛₚₑₐₖₑᵣ, Yₛₚₑₐₖₑᵣ) are the coordinates of the virtual listener 33 and of the speaker 3a in a system defined by the axes OX and OY and associated with the map, and where c is the speed of the sound.

It is considered, for example, that the longest two lateral walls (N and S) are not acoustically treated, such that they have a mean absorption coefficient α equal to 0.1 to 1 kHz (see table above).

It is considered, for example, that the other two walls (O and E) are coated with wall coverings, such that they have a mean absorption coefficient α equal to 0.5 to 1 kHz (see table above).

The results of the ray tracing simulation, which can be seen in FIG. 8, give, for a given frequency, an amplification of the sound level at the level of the virtual listener 33 of +10.1 dB with respect to the free-field signal.

This amplification must be compensated, at the given frequency (in this case, 1 kHz), by a gain value of −10.1 dB. This gain value is one of the reference audio parameters associated with the given frequency and with the reference position in the room corresponding to the position of the virtual listener 33.

This calculation is therefore performed for each of the nodes 34 of the grid, frequency by frequency.

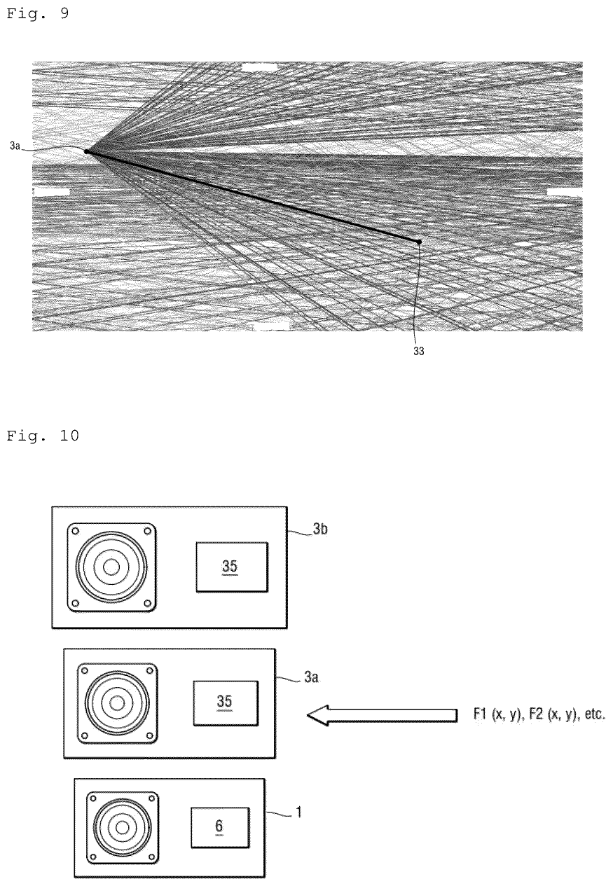

In order to improve precision, this calculation can be refined by integrating the directivity of the speaker of the sound source according to the frequencies. The results of this new simulation can be seen in FIG. 9.

In the preceding example, if the rays beyond +/−60° of the axis of the speaker 3a are removed, the effect of the room at the level of the virtual listener would reduce to +6.9 dB (instead of +10.1 dB without considering the directivity).

The simulation makes it possible to obtain, for each reference position, i.e. for each node 34 of the gate 32, and for each sound source, a transfer function defining a gain (function of the frequency) and a phase shift (function of the frequency).

Therefore, for each reference position (x, y) the following is achieved:
a transfer function F1 (x, y) for the first sound source;
a transfer function F2 (x, y) for the sound source number 2;
Etc.

It is noted that a loudspeaker is considered as forming a sound source. Consequently, multichannel speakers comprising a plurality of loudspeakers are considered as many sound sources positioned in the same place (and optionally with one same orientation).

The reference audio parameters are recorded in one of the (non-volatile) memories 9 of the processing unit 7.

Once the preliminary phase has been carried out, the operational phase can start.

It lasts until an optional following preliminary phase, which is implemented only in case of significant movement of one or more sound sources, or in case of significant change of a material of a wall of the room.

During the operational phase, the processing unit 7 of the set-top box 1 determines, in real time, the current position of the user 20 in the room when they listen to an audio signal played back by the set-top box 1 and the speakers 3a, 3b.

The determination of the current position of the user 20 is made by a UWB geolocation technique made by using the first UWB module 10 and the second UWB module 22.

The processing unit 7 thus plays back the audio signal by the sound sources by applying current audio parameters obtained from the reference audio parameters and which depend on the current position.

In a first embodiment, the current audio parameters which are applied are the reference audio parameters of a node 34 closest to the current position of the user 20.

In a second embodiment, the current audio parameters which are applied are obtained by averaging the reference audio parameters of several nodes 34 closest to the current position of the user 20. Averaging makes it possible to avoid transitions which are too sudden, when the user 20 moves.

In reference to FIG. 10, the processing unit 7 of the set-top box 1 transmits, in real time, the current audio parameters (F1 (x, y), F2 (x, y), etc.), associated with the current position of the user 20, to the audio module 6 of the set-top box 1 and to the audio module 35 of each speaker 3a, 3b.

The audio module 6, 35 of each sound source acquires the current audio parameters which are attributed to said sound source, performs processing to apply said current audio parameters, and plays back the audio signal. The processing unit 7 therefore controls the sound sources, such that they play back the audio signal by applying the current audio parameters.

Thus, the acoustic delays and phases are considered by considering the acoustic nature of the room.

Naturally, the invention is not limited to the embodiments described, but includes any variant entering into the field of the invention such as defined by the claims.

Architectures for the set-top box and for the smartphone have been described, which, naturally, are not limiting. The UWB modules could comprise different components from those described in this case. In the set-top box, the microcontroller and/or the UWB communication component of the first UWB module could, for example, be integrated in the processing unit.

The determination of the position of the walls, used to produce the map of the room, could be made differently. For example, if the user's smartphone (or any other mobile equipment) comprises a LiDAR (Light Detection And Ranging) sensor, it is possible to use it to perform a more precise and quicker 3D mapping of the room.

UWB radar technology can also be used to produce the map of the room. The set-top box can thus integrate a UWB radar. The UWB radar positions echoes in the room in polar coordinates. The echoes are then analysed to constitute a model of the room and to define the position of the walls, the angles between them, etc.

Also, the radar method also makes it possible to analyse the movement of a person, which can, as above, travel the room, in synchronisation with their smartphone (or another piece of mobile equipment) and the specific application in order to produce the calibration part of the room (route of the perimeter of the room, position of the sound sources). Via the application of the smartphone, the surface reflection data can also be entered, to return to the calibration of the room described above.

In the operational phase, the current position of the user could also be determined by the set-top box by using the UWB radar technology.

Likewise, the determination of the position of the sound sources could be made differently. A speaker could, for example, be provided with a UWB tag. The set-top box can thus determine the position of said sound source by using a UWB geolocation technique performed by using the first UWB module and the UWB tag.

It has been described that the invention is implemented in a piece of master equipment, which is the set-top box.

The invention could be implemented in another piece of master equipment, for example in a smart speaker, or in the user's smartphone.

The invention can be fully implemented in one single piece of master equipment, as it is moreover described in this case, in particular, when the processing unit integrates a processing component which is sufficiently powerful to perform the (DSP-type) simulation.

It is, however, possible to implement the invention in several pieces of master equipment. Thus, for example, the set-top box could carry out the mapping step (individually or by cooperating with other equipment, such as a smartphone, as it is described, in this case), and transmit the map or its constitutive elements to a cloud server, on which the simulation is performed. The set-top box thus recovers the reference audio parameters and controls the operational phase.

1. An audio playback method, implemented by one or more pieces of master equipment, and comprising a preliminary phase comprising the steps of:
producing a map of a room, wherein one or more sound sources are located, which comprises a position of each sound source and a position of walls of the room;
acquiring acoustic features of the walls;
performing a simulation, by using the map and the acoustic features of the walls, to simulate a propagation in the room of sounds emitted by the sound sources;
from results of the simulation, producing, for each reference position of a plurality of reference positions defined in the room, and for each sound source, reference audio parameters making it possible to optimise an audio playback of said sound source in said reference position;
the audio playback method further comprising an operational phase comprising the steps, carried out in real time, of:
determining a current position of a user in the room;
playing an audio signal back by the sound sources by applying current audio parameters obtained from reference audio parameters, and which depend on the current position.

2. The audio playback method according to claim 1, wherein the simulation uses a ray tracing technique.

3. The audio playback method according to claim 1, wherein the acoustic features of the walls comprise, for each wall, values for different frequencies of an absorption coefficient of a material of the wall or of a category of materials including said material.

4. The audio playback method according to claim 1, wherein the reference audio parameters comprise, for each reference position and for each sound source, gain and phase shift values for different frequencies, associated with said sound source.

5. The audio playback method according to claim 1, wherein the reference positions of the plurality of reference positions are nodes of a grid having a predefined grid cell length.

6. The audio playback method according to claim 5, wherein, during the operational phase, the current audio parameters which are applied are the reference audio parameters of a node closest to the current position.

7. The audio playback method according to claim 5, wherein, during the operational phase, the current audio parameters which are applied are obtained by averaging the reference audio parameters of several nodes closest to the current position.

8. The audio playback method according to claim 1, wherein at least one of the pieces of master equipment comprises a first UWB module, and wherein the production of the map and/or the detection of the current position of the user are implemented by using the first UWB module.

9. The audio playback method according to claim 1, wherein the preliminary phase comprises the steps, to determine the position of the wall, of:
emitting a first message intended for the user to request them to perform a route along the walls closest to these;
determining the position, in real time, of the user when they perform said route, and determining the position of the walls from this position in real time.

10. The audio playback method according to claim 8, wherein the user is provided, when they perform said route, with a piece of mobile equipment comprising a second UWB module, the determination of the position in real time of the user being made by a UWB geolocation technique, by using the first UWB module and the second UWB module.

11. The audio playback method according to claim 8, wherein, during the operational phase, the user is provided with a piece of mobile equipment comprising a second UWB module, the determination of the current position of the user being made by a UWB geolocation technique made by using the first UWB module and the second UWB module.

12. The audio playback method according to claim 8, wherein the first UWB module is arranged to implement a UWB radar technology, the determination of the position of the walls of the room being made by the master equipment by using said UWB radar technology.

13. The audio playback method according to claim 8, wherein the user, during the preliminary phase, is provided with a piece of mobile equipment comprising a second UWB module, the preliminary phase comprising the step, for at least one sound source, of emitting a second message intended for the user to request them to position the mobile equipment in the immediate proximity of the sound source, the position of said sound source thus being assimilated to the position of the mobile equipment, which is determined by a UWB geolocation technique by using the first UWB module and the second UWB module.

14. The audio playback method according to claim 8, wherein at least one sound source comprises a UWB tag, the master equipment being arranged to determine the position of said sound source by using a UWB geolocation technique made by using the first UWB module (10) and the UWB tag.

15. A master equipment comprising a first UWB module arranged to perform a geolocation, and a processing unit arranged to implement the audio playback method according to claim 1.

16. The master equipment according to claim 15, the master equipment being a set-top box.

17. (canceled)

18. A non-transitory recording medium which can be read by a computer, on which a computer program is recorded, wherein the computer program comprising instructions which make a processing unit of a master equipment execute steps of the audio playback method according claim 1, wherein the master equipment comprising a first UWB module arranged to perform a geolocation, and the processing unit is arranged to implement the audio playback method.
